(19) United States
(12) Patent Application Publication
(10) Pub. No.: US 2008/0133844 A1
(43) Pub. Date: Jun. 5, 2008

(54) METHOD AND APPARATUS FOR EXTENDING LOCAL CACHES IN A MULTIPROCESSOR SYSTEM

(76) Inventors: Srinivasan RAMANI, Cary, NC (US); Kartik Sudeep, Austin, TX (US)

Correspondence Address: SAWYER LAW GROUP LLP, PO BOX 51418, PALO ALTO, CA, 94303, US

(21) Appl. No.: 11/566,187

(22) Filed: Dec. 1, 2006

(51) Int. Cl. G06F 12/08

(52) U.S. Cl. 711/146; 711/E12.057; 711/E12.032

(57) ABSTRACT

Methods, computer program products, and systems for caching data in a multiprocessor system are provided. In one implementation, the method includes generating a memory access request for data, which data is required for a processor operation associated with the first processor. Responsive to the data not being cached within a first cache associated with the first processor, the method further includes snooping a second cache associated with the second processor to determine whether the data has previously been cached in the second cache, possibly as a result of a previous “low priority” request for the data by the first processor and responsive to the data being cached within the second cache associated with the second processor, passing the data from the second cache to the first processor.

### FIELD OF THE INVENTION

The present invention relates generally to processing systems and circuits, and more particularly to caching data in a multiprocessor system.

### BACKGROUND OF THE INVENTION

Processor systems typically include caches to reduce latency associated with memory accesses. A cache is generally a smaller, faster memory (relative to a main memory) that is used to store copies of data from the most frequently used main memory locations. In operation, once a cache becomes full (or in the case of a set-associative cache, once a set becomes full), subsequent references to cacheable data (in a main memory) will typically result in eviction of data previously stored in the cache (or the set) in order to make room for storage of the newly referenced data in the cache (or the set). In conventional processor systems, the eviction of previously stored data from a cache typically occurs even if the newly referenced data is not important—e.g., the newly referenced data will not be referenced again in subsequent processor operations. Consequently, in such processor systems, if the evicted data is, however, referenced in subsequent processor operations, cache misses will occur which generally results in performance slowdowns of the processor system.

Frequent references to data that may only be used once in a processor operation leads to cache pollution, in which important data is evicted to make room for transient data. One approach to address the problem of cache pollution is to increase the size of the cache. This approach, however, results in increases in cost, power, and design complexity of a processor system. Another solution to the problem of cache pollution is mark (or tag) transient data as being non-cacheable. Such a technique, however, requires prior identification of the areas in a main memory that stores transient (or infrequently used) data. Also, such a rigid demarcation of data may not be possible in all cases.

### BRIEF SUMMARY OF THE INVENTION

In general, in one aspect, this specification descries a method for caching data in a multiprocessor system including a first processor and a second processor. The method includes generating a memory access request for data, in which the data is required for a processor operation associated with the first processor. The method further includes, responsive to the data not being cached within a first cache associated with the first processor, snooping a second cache associated with the second processor to determine whether the data has previously been cached in the second cache as a result of an access to that data from the first processor. Responsive to the data being cached within the second cache associated with the second processor, the method further includes passing the data from the second cache to the first processor.

In general, in one aspect, this specification describes a multiprocessor system including a first processor including a first cache associated therewith, a second processor including a second cache associated therewith, and a main memory to store data required by the first processor and the second processor. The main memory is controlled by a memory controller that is in communication with each of the first processor and the second processor through a bus, and the second cache associated with the second processor is operable to cache data from the main memory corresponding to a memory access request of the first processor.

In general, in one aspect, this specification describes a computer program product, tangibly stored on a computer readable medium, for caching data in a multiprocessor system, in which the multiprocessor system includes a first processor and a second processor. The computer program product compromises instructions to use a programmable processor to monitor a cache miss rate of the first processor, and cache data requested by the second processor within a firs cache associated with the first processor responsive to the cache miss rate of the first processor being low.

Implementation can provide one or more of the following advantages. The techniques for caching data in a multiprocessor system provide a way to extend the available caches in which data (required by a given processor in a multiprocessor system) may be stored. For example, in one implementation, unused portions of a cache associated with a first processor (in the multiprocessor system) are used to store data that is requested by a second processor. Further, the techniques described herein permits more aggressive software and hardware prefetches in the data corresponding to a speculatively executed path can be cached within a cache of an adjacent processor to reduced cache pollution should a predicted path be due to a mispredicted branch. This also provides a way to cache data for the alternate path. As another example where prefetching can be made more aggressive, the hardware prefetcher can be enhanced to recognize eviction of cache lines that are used later. In these cases, the hardware prefetcher can indicated that prefetch data should be stored in a cache associated with a different processor. Similarly, when there is likelihood of cache pollution, software prefetches placed by a compiler an indicate via special instruction fields that the prefetched data should be placed in a cache associated with a different processor. In addition, the techniques are scalable according to the number of processor within a multiprocessor system. The techniques can also be used in conjunction with conventional techniques such as victim caches and cache snarfing to increase performance of a multiprocessor system. The implementation can be controlled by the operating system and hence be made transparent to user applications.

The details of one or more implementations are set forth in the accompanying drawings and the description below. Other features and advantages will be apparent from the description and drawings.

### BRIEF DESCRIPTION OF THE DRAWINGS

FIG. 1 is a block diagram of a multiprocessor system in accordance with one implementation.

FIG. 2 illustrates a flow diagram of a method for storing data in a cache in accordance with one implementation.

FIGS. 3A-3B illustrate a block diagram of a multiprocessor system in accordance with one implementation.

Like reference symbols in the various drawings indicate like elements.

### DETAILED DESCRIPTION OF THE INVENTION

The present invention relates generally to processing systems and circuits, and more particularly to caching data in a multiprocessor system. The following description is presented to enable one of ordinary skill in the art to make and use the invention and i provided in the context of a patent application and its requirements. The present invention is not intended to be limited to the implementations shown but is to be accorded with widest scope consistent with the principles and features described herein.

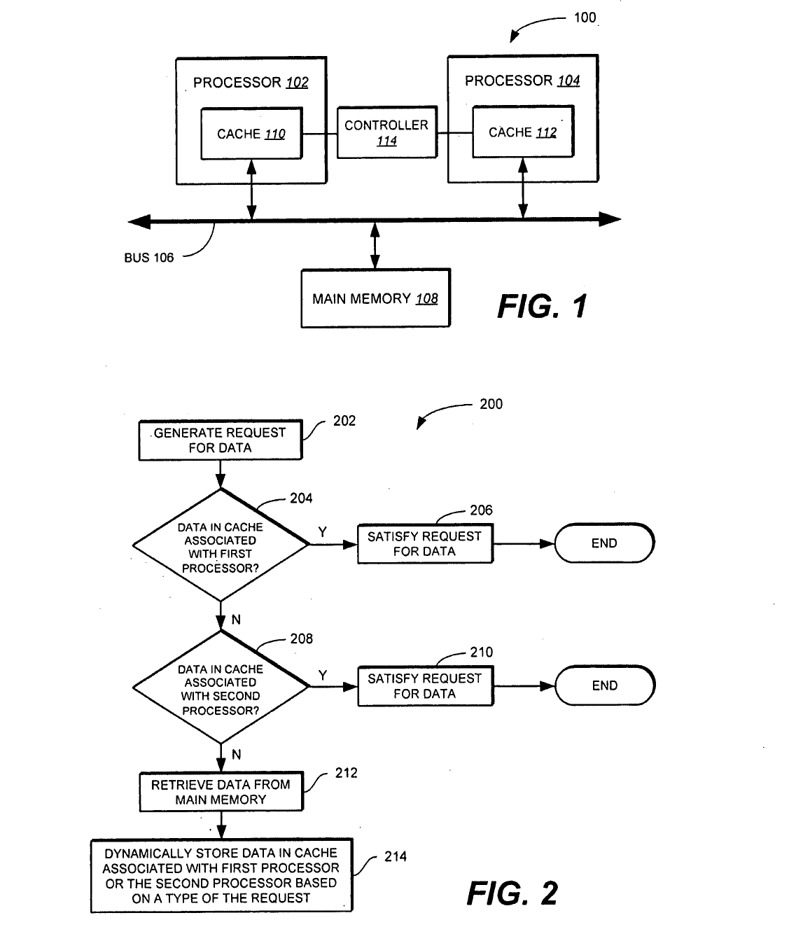

FIG. 1 illustrates a multiprocessor system 100 in accordance with one implementation. The multiprocessor system 100 includes a processor 102 and a processor 104 that are both in communication with a bus 106. Although the multiprocessor system 100 is shown including two processor, the multiprocessor system 100 can include any number of processors. Moreover, the processor 102 and the processor 104 can be tightly-coupled (as shown in FIG. 1), or the processor 102 and the processor 104 can be loosely-coupled. Also, the processor 102 and the processor 104 can be implemented on the same chip, or can be implemented on separate chips.

The multiprocessor system 100 further includes a main memory 108 that stores data required by the processor 102 and the processor 104. The processor 102 includes a cache 110, and the processor 104 includes a cache 112. In one implementation, the cache 110 is operable to cache data (from the main memory 108) that is to be processed by the processor 102, as well as cache data that is to be processed by the processor 104. In like manner, (in one implementation) the cache 112 is operable to cache data that is to be processed by the processor 104, as well as cache data that is to be processed by the processor 102. The cached 100 and/or the cache 112 can be an L1 (level 1) cache, and L2 (level 2) cache, or a hierarchy of cache levels. In one implementation, the decision of whether to store data from main memory 108 within the cache 110 or the cache 112 is determined by a controller 114. In one implementation, the controller 114 is a cache coherency controller (e.g., in the North Bridge) operable to manage conflicts and maintain consistency between the caches 110, 112 and the main memory 108.

FIG. 2 illustrates a method 200 for storing data in a multiprocessor system (e.g., multiprocessor system 100) in accordance with one implementation. A memory access request or data is generated by a first processor (e.g., processor 102) (step 202). The memory access request for data can be, for example, a load memory operation generated by a load/store execution unit associated with the first processor. A determination is made whether the data requested by the first processor is cached (or store) in a cache (e.g., cache 110) associated with (or primarily dedicated to) the first processor (step 204). If the data requested by the first processor is cached in a cache associated with the first processor (i.e., there is a cache hit), then the memory access request is satisfied (step 206). The memory access request can be satisfied by the cache forwarding the requested data to pipelines and/or register file of the first processor.

If, however, the data requested by the first processor is not cached in a cache associated with the first processor—i.e., there is a cache miss—then a determination is made (e.g., by controller 114) using conventional snooping mechanism whether the data requested by the first processor is cached in a cache (e.g., cache 112) associated with a second processor (e.g., processor 104) (step 208). If the data requested by the first processor is cached in a cache associated with the second processor, then the memory access request is satisfied (step 210). The difference from conventional techniques is that the cache associated with the second processor might have data in it that the second processor did not request using a load instruction or prefetch. The memory access request can be satisfied by the cache (associated with the second processor) forwarding the data to the pipelines and/or register file of the first processor. In one implementation, the data stored in the cache associated with the second processor is moved or copied to the cache associated with the first processor. In such an implementation, an access threshold can be set (e.g., through the controller 114) that indicates the number of accesses of the data that is required prior to the data being moved from the cache associated with the second processor to the cache associated with the first processor. For example, if the access threshold is set at “1”, then the very first access of the data in the cache associated with the second processor will prompt the controller to move the data to the cache associated with the first processor. If in step 208 the data requested by the first processor is not cached in a cache associated with the second processor (or any other processor in the multiprocessor system), the data is retrieved from a main memory (e.g., main memory 108) (step 212).

The data retrieved from the main memory is dynamically stored in a cache associated with the first processor or a cache associated with the second processor based on a type (or classification) of the memory access request (step 214). In one implementation, the data retrieved from the main memory is stored in a cache of a given processor based on a type of priority associated with the memory access request. For example, (in one implementation) low priority requests for data of the first processor are stored in a cache associated with a second processor. Accordingly, in this implementation, cache pollution of the first processor is avoided. A memory access request from a given processor can be set as a low priority request through a variety of suitable techniques. More generally, the memory access requests (from a given processor) can be classified (or assigned a type) in accordance with any pre-determined criteria.

In one implementation, a (software) compiler examines code and/or an execution profile to determine whether software prefetch (cache or stream touch) instructions will benefit from particular prefetch requests being designated as low priority requests—e.g., the compiler can designate a prefetch request as a low priority request if the returned data is not likely to be used again by the processor in a subsequent processor operation of if the returned data will likely cause cache pollution. In one implementation, the compiler sets bits in a software prefetch instruction, which indicate that the returned data (or line) should be placed in a cache associated with another processor (e.g., an L2 cache of an adjacent processor). The returned data can be directed to the cache associated with the other processor by the controller 114 (FIG. 1). Thus, in one implementation, a processor can cache data within a cache associated with the processor, even though the processor did not request the data.

In one implementation, hardware prefetch logic associated with a given processor is designed to recognize when data (associated with a prefetch request) returned from main memory evicts important data from a cache. The recognition of the eviction of important data can serve as a trigger for the hardware prefetch logic to set bits to designate subsequent prefetch requests as low priority requests. Thus, returned data associated with the subsequent prefetch requests will be placed in a cache associated with another processor. In one implementation, speculatively executed prefetches and memory access—e.g., as a result of a branch prediction—are designated as low priority requests. Such a designation prevents cache pollution in the case of incorrectly speculated executions which are not cancelled prior to data being returned from a main memory. Thus, data corresponding to an alternate path—i.e., a path that is eventually determined to have been incorrectly predicted—can be cached (in the second processor's cache). Such caching of data corresponding to the alternate path can in some cases, reduce data access times on a subsequent visit to the branch, if the alternate path is taken at that time.

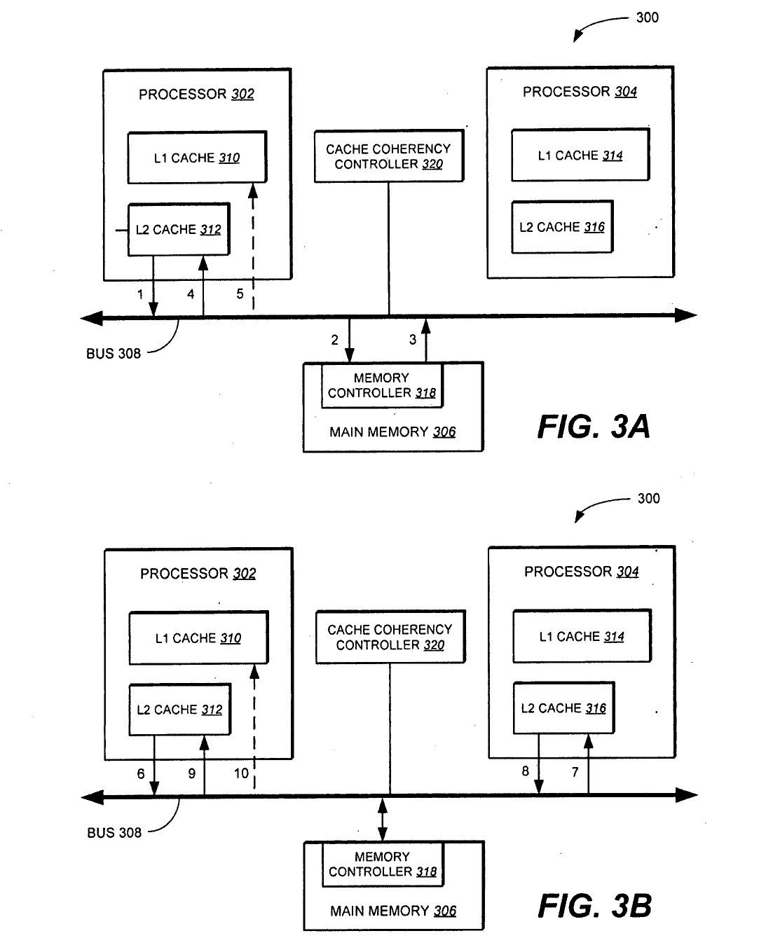

FIGS. 3A-3B illustrate a sequence of operations for processing memory access request in a multiprocessor system 300. In the implementation shown in FIGS. 3A-3B, the multiprocessor system 300 includes a processor 302 and a processor 304 that are each in communication with a main memory subsystem 306 through a bus 308. The processor 302 includes an L1 cache 310 and an L2 cache 312, and the processor 304 includes an L1 cache 314 and L2 cache 316. The main memory subsystem 306 includes a memory controller 318 (as part of a North Bridge or on-chip) for controlling accesses to data within the main memory 306, and the multiprocessor system 300 further includes a cache coherency controller 320 (possibly in the North Bridge) to manage conflicts and maintain consistency between the L1 cache 310, L2 cache 312, L1 cache 314, L2 cache 316, and the main memory 306. Although the multiprocessor system 300 is shown including two processors, the multiprocessor system 300 can include any number of processors. Further, the processors 302, 304 include both an L1 cache and an L2 cache for purposes of illustration. In general, the processors 302, 304 can be adapted to other cache hierarchy schemes.

Referring first to FIG. 3A, a first type of memory access request is shown that is consistent with conventional techniques. That is, if data (e.g., a line) requested by a processor is not stored (or cached) within a local L1 or L2 cache, an no other cache has the data (as indicated by their snoop responses), then the processor sends the memory access request to the memory controller of the main memory which returns the data back to the requesting processor. The data returned from the main memory can be cached within the local L1 or L2 cache of the requesting processor, and if another processor requests the same data, the use of the conventional cache coherency protocols, such as the four state MESI (Modified, Exclusive, Shard, Invalid) protocol for cache coherency can dictate whether the data can be provided from the caches of this processor. Thus, for example, as shown in FIG. 3A, the L2 cache 312 (of processor 302) issues a memory access request for data (which implies that the data needed by the processor 302 is not cached within the L1 cache 310 or the L2 cache 312 (step 1). The memory access request reaches the main memory 306 through the memory controller 318 (step 2). The main memory 306 returns the requested data (or line) to the bus (step 3). The data is then cached within the L2 cache 312 of the processor 302 (step 4). alternatively, the data can be cached within the L1 cache 310 (step 5), or be passed directly to the pipelines of the processor 302 without being cached within the L1 cache 310 or the L2 cache 312.

Referring to FIG. 3B, a press for handling a second type of memory access request—i.e., a low priority request—is shown. In particular, the L2 cache 312 issues a low priority request for data (step 6). The low priority request an be, e.g., a speculative prefetch request, or other memory access request designated as a low priority request. The L2 cache 316 associated with the processor 304 is snooped to determine if the data is cached within the L2 cache 316 (step 7). if the requested data is cached within the L2 cache 316, then the L2 cache 316 satisfies the low priority request (step 8), and no memory access is required in the main memory 306. Accordingly, when the data is passed from the L2 cache 316, the data an be cached within the L2 cache 312 (step 9), cached within the L1 cache 310, or cached within both the L2 cache 312 and the L1 cache 310. Alternatively, the data from the L2 cache 316 can be passed directly to the pipelines and/or a register file of the processor 302 (which can alleviate cache pollution based upon application requirements).

In one implementation, the cache coherency controller 320 sets bits associated with the data stored in the L2 cache 316 that indicate the number of times that the data has been accessed by the processor 302. Further, in this implementation, a user can set a pre-determined access threshold that indicates the number of accesses of the data (of the processor 302) that is required prior to the data being copied from the L2 cache 316 to a cache associated with the processor 302—i.e., the L1 cache 310 or the L2 cache 312. Thus, for example, if the access threshold is set to 1 for a given line of data stored in the L2 cache 316, then the very first access of the line of data in the L2 cache 316 will prompt the cache coherency controller 320 to move the line of data from the L2 cache 316 to a cache associated with the processor 302. In like manner, if the access threshold is set to 2, then the second access of the line of data in the L2 cache 316 by the processor 302 will prompt the cache coherency controller 320 to copy the line of data from the L2 cache 316 to a cache associated with the processor 302. In this implementation, a user can control an amount of cache pollution by tuning the access threshold. The user can consider factors including cache coherency, inclusiveness, and the desire to keep cache pollution to a minimum when establishing access thresholds for cached data.

In one implementation, an operating system can be used to monitor the load on individual processors within a multiprocessor system and their corresponding cache utilizations and cache miss rates to control whether the cache coherency controller should enable data corresponding to a low priority request of a first processor to be stored within a cache associated with a second processor. For example, if the operating system detects that the cache associated with a second processor is being underutilized—or the cache miss rate of the cache is low—then the operating system can direct the cache coherency controller to store data requested by the first processor within the cache associated with a second processor. In one implementation, the operating system can dynamically enable and disable data corresponding to a low priority request of a first processor to be stored within a cache associated with a second processor in a transparent manner during operation.

One or more of method steps described above can be performed by one or more programmable processors executing a computer program to perform functions by operating on input data and generating output. Generally, the techniques described above can take the form of an entirely hardware implementation, or an implementation containing both hardware and software elements. Software elements include, but are not limited to, firmware, resident software, microcode, etc. Furthermore, some techniques described above may take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, or removable computer diskette, a random access memory (RAM), a read-only memory (ROM), a rigid magnetic disk and an optical disk. Current examples of optical disks include compact disk—read only memory (CD-ROM), compact disc—read/write (CD-/R/W) and DVD.

Various implementations for caching data in a multiprocessor system have been described. Nevertheless, various modifications may be made to the implementations descried above, and those modifications would be within the scope of the present invention. For example, method steps discussed above can be performed in a different order and still achieve desirable results. Also, in general, method steps discussed above can be implemented through hardware logic, or a combination of software and hardware logic. The techniques discussed above can be applied to multiprocessor systems including, for example, in-order execution processors, out-of-order execution processors, both programmable and non-programmable processors, processors with on-chip or off-chip memory controllers and so on. Accordingly, many modifications may be made without departing from the scope of the present invention.

What is claimed is:

1. A method for caching data in a multiprocessor system including a first processor and a second processor, the method comprising:
generating a memory access request for data, the data being required for a processor operation associated with the first processor;
responsive to the data not being cached within a first cache associated with the first processor, snooping a second cache associated with the second processor to determine whether the data has previously been cached in the second cache as a result of an access to that data from the first processor; and
responsive to the data being cached within the second cache associated with the second processor, passing the data from the second cache to the first processor.

2. The method of claim 1, wherein responsive to the data also not being cached within the second cache of the second processor,
retrieving the data from a main memory associated with the multiprocessor system; and
dynamically caching the data retrieved from the main memory in the first cache associated with the first processor or the second cache associated with the second processor based on a type of the memory access request.

3. The method of claim 2, wherein generating a memory access request for data includes designating the type of the memory access request based on a pre-defined criteria.

4. The method of claim 3, wherein designating the type of the memory access request includes designating the type of the memory access request to be a low priority request.

5. The method of claim 4, wherein dynamically caching the data retrieved from the main memory includes caching the data associated with the low priority request in the second cache associated with the second processor.

6. The method of claim 4, wherein the low priority request comprises a hardware prefetch request or a software prefetch request.

7. The method of claim 1, further comprising setting an access threshold for the data cached within the second cache, the access threshold indicating a number of accesses of the data that is required prior to the data being copied from the second cache associated with the second processor to the first cache associated with the first processor.

8. The method of claim 1, wherein passing the data from the second cache to the first processor includes passing the data from the second cache directly to a register file or pipelines associated with the first processor.

9. The method of claim 1, further comprising:
monitoring a cache miss rate of the second processor; ;and
caching data requested by the first processor within the second cache associated with the second processor responsive to the cache miss rate of the second processor being low.

10. The method of claim 1, wherein the first processor and the second processor are implemented on a same chip or different chips.

11. A multiprocessor system comprising:
a first processor including a first cache associated therewith;
a second processor including a second cache associated therewith; and
a main memory to store data required by the first processor and the second processor, the main memory being controlled by a memory controller that is in communication with each of the first processor and the second processor through a bus,
wherein the second cache associated with the second processor is operable to cache data from the main memory corresponding to a memory access request of the first processor.

12. The multiprocessor system of claim 11, wherein the memory access request of the first processor is a low priority access request.

13. The multiprocessor system of claim 12, wherein the low priority request comprises a hardware prefetch request or a software prefetch request.

14. The multiprocessor system of claim 12, further comprising a controller to direct data corresponding to the low priority request from the main memory to the second cache for caching of the data.

15. The multiprocessor system of claim 14, wherein the controller is a cache coherency controller operable to manage conflicts and maintain consistency of data between the first cache, the second cache and the main memory.

16. The multiprocessor system of claim 11, wherein the first processor and the second processor are tightly-coupled and implemented on a same chip or different chips.

17. The multiprocessor system of claim 11, wherein the first processor and the second processor are loosely-coupled.

18. A computer program product, tangibly stored on a computer readable medium, for caching data in a multiprocessor system, the multiprocessor system including a first processor and a second processor, the computer program product comprising instructions to cause a programmable processor to:
monitor a cache miss rate of the first processor; and
cache data requested by the second processor within a first cache associated with the first processor responsive to the cache miss rate of the first processor being low.

19. The computer program product of claim 18, wherein the first processor and the second processor are tightly-coupled and implemented on a same chip or different chips.

20. The computer program product of claim 18, wherein the first processor and the second processor are loosely-coupled.
